(19) United States
(12) Patent Application Publication
(10) Pub. No.: US 2011/0032360 A1
(43) Pub. Date: Feb. 10, 2011

(54) SYSTEMS, METHODS, AND APPARATUS FOR MONITORING AN AREA

(76) Inventors: Ronald Carter, Matthews, NC (US); Scott Williams, Charlotte, NC (US)

Correspondence Address: TILLMAN WRIGHT, PLLC, PO BOX 49309, CHARLOTTE, NC, 28277-0076, US

(21) Appl. No.: 12/834,828

(22) Filed: Jul. 12, 2010

Related U.S. Application Data
(60) Provisional application No. 61/224,898, filed on Jul. 12, 2009.

(51) Int. Cl. H04N 7/18

(52) U.S. Cl. 348/153; 348/E07.085

(57) ABSTRACT

A system for transgression detection includes a plurality of modules, each module comprising a video camera, a microphone, an electronic display, and a processor; a plurality of sensors, each sensor configured for electronic communication with at least one of the plurality of modules; and a remote device configured to allow a user to both control a module via electronic communication, and interact with a module via electronic communication; wherein at least one module of the plurality of modules is configured to be triggered by a communication from a sensor of the plurality of sensors; and wherein each sensor of the plurality of sensors comprises a fiber optic line.

### CROSS-REFERENCE TO RELATED APPLICATION

The present application is a U.S. nonprovisional patent application of, and claims priority under 35 U.S.C. §119(e) to, U.S. provisional patent application Ser. No. 61/224,898, filed Jul. 12, 2009, which provisional patent application is incorporated by reference herein.

The present application hereby incorporates herein by reference:
(a) U.S. Pat. No. 7,193,644, issued Mar. 20, 2007, titled “Automated Audio Video Messaging And Answering System”;
(b) U.S. Patent Application Publication No. 2007/0188612, published Aug. 16, 2007, titled “Video System for Individually Selecting and Viewing Events at a Venue”;
(c) U.S. Patent Application Publication No. 2007/0103548, published May 10, 2007, titled “Audio-Video Communication System For Receiving Person At Entrance”;
(d) U.S. Patent Application Publication No. 2007/0103541, published May 10, 2007, titled “Two-Way Audio-Video Communication Method For Receiving Person At Entrance”;
(e) U.S. Patent Application Publication No. 2007/0103542, published May 10, 2009, titled “Video Communication Method For Receiving Person At Entrance”;
(f) U.S. Patent Application Publication No. 2007/0188611, published Aug. 16, 2007, titled “Method for Providing Multiple Viewing Opportunities of Events at a Venue”;
(g) U.S. Patent Application Publication No. 2008/0136908, published Jun. 12, 2008, titled “AUDIO-VIDEO COMMUNICATION SYSTEM FOR RECEIVING PERSON AT ENTRANCE”;
(h) U.S. Patent Application Publication No. 2008/0117299, published May 22, 2008, titled “AUDIO-VIDEO COMMUNICATION SYSTEM FOR RECEIVING PERSON AT ENTRANCE”;
(i) U.S. patent application Ser. No. 12/464,075, filed May 11, 2009, titled “REAL ESTATE COMMUNICATIONS AND MONITORING SYSTEMS AND METHODS FOR USE BY REAL ESTATE AGENTS”, and any publications thereof;
(j) U.S. patent application Ser. No. 12/464,093, filed May 11, 2009, titled “SYSTEMS, METHODS, AND APPARATUS FOR METAL DETECTION, VIEWING, AND COMMUNICATIONS”, and any publications thereof;
(k) U.S. patent application Ser. No. 12/464,022, filed May 11, 2009, titled “COMMUNICATIONS AND SURVEILLANCE SYSTEMS, METHODS, AND APPARATUS”, and any publications thereof; and
(l) the entire disclosure of
   (1) U.S. Provisional Patent Application Ser. No. 61/052,240, filed May 11, 2008, titled “METAL DETECTION SECURITY”, a copy of which is attached hereto as Appendix A,
   (2) U.S. Provisional Patent Application Ser. No. 61/052,242, filed May 11, 2008, titled “REAL ESTATE AUDIO/VIDEO MONITORING COMMUNICATION SYSTEM”, a copy of which is attached hereto as Appendix B,
   (3) U.S. Provisional Patent Application Ser. No. 61/052,246, filed May 11, 2008, titled “MOLE SURVEILLANCE”, a copy of which is attached hereto as Appendix C, and
   (4) U.S. Provisional Patent Application Ser. No. 61/176,871, filed May 8, 2009, titled “SYSTEMS, METHODS, AND APPARATUS FOR MONITORING AN AREA”, a copy of which is attached hereto as Appendix D.

Further, the following U.S. Pat. Nos. are each incorporated herein by reference: 6,856,400; 6,900,897; 6,856,400; 7,042,573; 7,379,168; 7,388,673; 7,440,087; and 6,376,830. Additionally, the disclosure of attached Exhibit E is hereby incorporated herein by reference.

### COPYRIGHT STATEMENT

All of the material in this patent document is subject to copyright protection under the copyright laws of the United States and other countries. The copyright owner has no objection to the facsimile reproduction by anyone of the patent document or the patent disclosure, as it appears in official governmental records but, otherwise, all other copyright rights whatsoever are reserved.

### BACKGROUND OF THE INVENTION

The present invention generally relates to area monitoring. A need exists for improvement in area monitoring. This, and other needs, are addressed by one or more aspects of the present invention.

### SUMMARY OF THE INVENTION

The present invention includes many aspects and features. Moreover, while many aspects and features relate to, and are described in, the context of area monitoring, the present invention is not limited to use only in this context, as will become apparent from the following summaries and detailed descriptions of aspects, features, and one or more embodiments of the present invention.

Accordingly, one aspect of the present invention relates to a method for transgression detection.

Another aspect of the present invention relates to a system for transgression detection.

Another aspect of the present invention relates to apparatus for transgression detection.

Another aspect of the present invention relates to a system for transgression detection comprising a plurality of modules, each module comprising a video camera, a microphone, an electronic display, and a processor. The system further includes a plurality of sensors, each sensor being configured for electronic communication with at least one of the plurality of modules. The system still further includes a remote device configured to allow a user to both control a module via electronic communication, and interact with a module via electronic communication. At least one module of the plurality of modules is configured to be triggered by a communication from a sensor of the plurality of sensors.

In a feature of this aspect, the remote device is a handheld device.

In a feature of this aspect, the handheld device is configured for direct communications with a module of the plurality of modules when in range of the module, and is configured for infrastructure communications via a network with the module when not in range of the module.

In a feature of this aspect, each sensor of said plurality of sensors comprises a fiber optic line.

In a feature of this aspect, each fiber optic line is buried.

In a feature of this aspect, each fiber optic line is buried between one and a half and two feet below ground level.

In addition to the aspects and features of the present invention mentioned herein, and in the incorporated Appendices, patent application publications, and patents, it should be noted that the present invention further encompasses the various possible combinations and subcombinations of such aspects and features.

### BRIEF DESCRIPTION OF THE DRAWINGS

FIG. 1 illustrates an exemplary transgression detection system.

FIGS. 2-5 illustrate exemplary pop up modules for use with a transgression detection system.

### DETAILED DESCRIPTION

As a preliminary matter, it will readily be understood by one having ordinary skill in the relevant art (“Ordinary Artisan”) that each present invention has broad utility and application. Furthermore, any embodiment discussed and identified as being “preferred” is considered to be part of a best mode contemplated for carrying out one of the present inventions. Other embodiments also may be discussed for additional illustrative purposes in providing a full and enabling disclosure of each present invention. Moreover, many embodiments, such as adaptations, variations, modifications, and equivalent arrangements, will be implicitly disclosed by the embodiments described herein and fall within the scope of one or both present inventions.

Accordingly, while each present invention is described herein in detail in relation to one or more embodiments, it is to be understood that this disclosure is illustrative and exemplary of each present invention, and is made merely for the purposes of providing a full and enabling disclosure of each present invention. The detailed disclosure herein of one or more embodiments is not intended, nor is to be construed, to limit the scope of patent protection afforded either present invention, which scope is to be defined by the claims and the equivalents thereof. It is not intended that the scope of patent protection afforded either present invention be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of each present invention. Accordingly, it is intended that the scope of patent protection afforded each present invention is to be defined by the appended claims rather than the description set forth herein.

Additionally, it is important to note that each term used herein refers to that which the Ordinary Artisan would understand such term to mean based on the contextual use of such term herein. To the extent that the meaning of a term used herein—as understood by the Ordinary Artisan based on the contextual use of such term—differs in any way from any particular dictionary definition of such term, it is intended that the meaning of the term as understood by the Ordinary Artisan should prevail.

Regarding applicability of 35 U.S.C. §112, ¶6, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. Thus, reference to “a picnic basket having an apple” describes “a picnic basket having at least one apple” as well as “a picnic basket having apples.” In contrast, reference to “a picnic basket having a single apple” describes “a picnic basket having only one apple.”

When used herein to join a list of items, “or” denotes “at least one of the items,” but does not exclude a plurality of items of the list. Thus, reference to “a picnic basket having cheese or crackers” describes “a picnic basket having cheese without crackers”, “a picnic basket having crackers without cheese”, and “a picnic basket having both cheese and crackers.” Finally, when used herein to join a list of items, “and” denotes “all of the items of the list.” Thus, reference to “a picnic basket having cheese and crackers” describes “a picnic basket having cheese, wherein the picnic basket further has crackers,” as well as describes “a picnic basket having crackers, wherein the picnic basket further has cheese.”

A transgression detection system in accordance with a preferred embodiment of the present invention comprises one or more transgression sensors and one or more communication modules configured for electronic communication with the one or more transgression sensors.

Each communication module preferably includes a video camera, speakers, a microphone, and a transceiver (preferably a radio-frequency (RF) transceiver), although in some implementations, one or more of these elements may not be present. Further, a module may include the functionality of a DVMS module, or may even comprise a DVMS module, as disclosed in one or more patents and patent application publications incorporated herein by reference.

The module further may include a battery, and/or may be connected to a power line or source. In at least some implementations, a module may be wholly or partially solar powered.

In at least some implementations, one or more of the modules includes a sensor, such as, for example, a proximity sensor. In some of these implementations, such sensors comprise transgression sensors, and are the sole transgression sensors utilized by the system, while in other implementations, one or more additional transgression sensors that are not a part of any module are nonetheless in electronic communication, either wireless or wired, with one or more modules. In some implementations, a module does not include a transgression sensor and instead is merely in electronic communication, either wired or wireless, with one or more external transgression sensors.

In a preferred implementation, the system includes external transgression sensors configured to detect the transgression of an area by a person or machine. In a more preferred implementation, transgression sensors are configured to detect the transgression of a border, such as a national border line, by a person or vehicle. Such external transgression sensors are preferably distributed proximate a border, such as, for example, mounted or buried in an area immediately proximate the border line. The transgression sensors may be distributed evenly proximate the border to as to detect the transgression of an area immediately proximate the border. This area may, depending on the application, cover an area up to several feet from the border or up to hundreds of miles from the border, or anywhere in between.

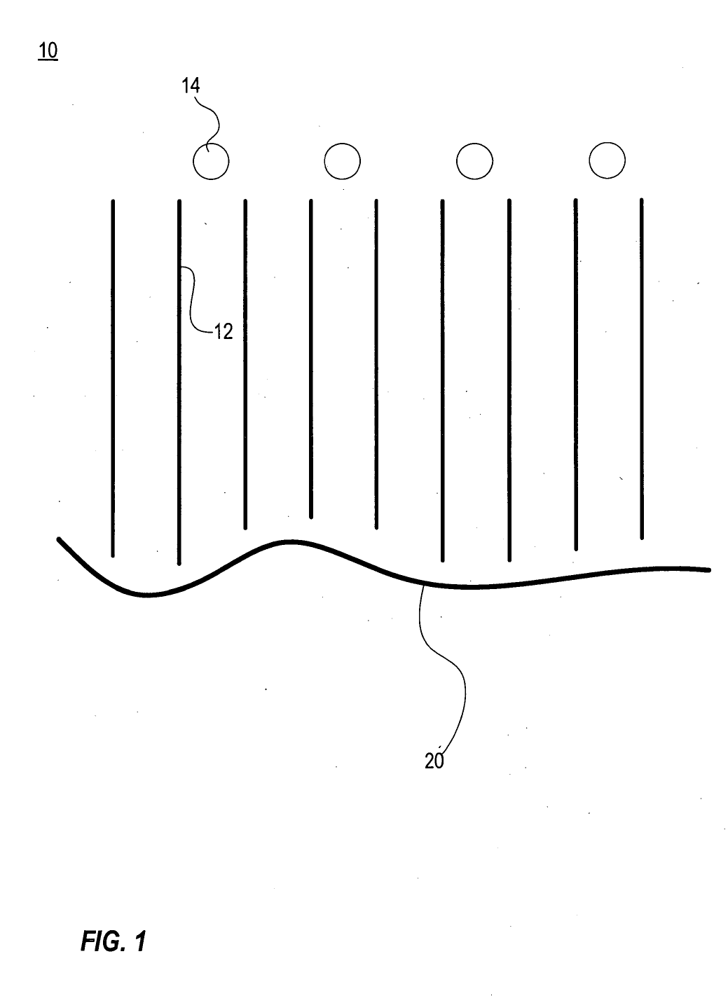

FIG. 1 illustrates an exemplary transgression detection system 10 comprising transgression sensors 12 distributed in an area just inside a border 20. In a preferred implementation, each transgression sensor 12 comprises a fiber optic line. Preferably, each fiber optic line is buried one and a half to two feet (1.5 to 2 feet) below ground level. In some preferred implementations, each fiber optic line is around one and four tenths of a mile (1.4 miles) in length, while in other preferred implementations, each fiber optic line is between five to ten kilometers (5-10 kms) in length.

Each fiber optic line functions as a fiber optic sensing line. It will be appreciated that various methodologies of accomplishing such fiber optic sensing are known in the art. For example, polarization sensing, an optical backscatter reflectometer, and/or an optical timedomain reflectometer may be used. Preferably, fiber fingerprinting is used. Technologies that may be used in accordance with one or more preferred embodiments are outlined in the following U.S. patents, each of which is hereby incorporated herein by reference: 6,856,400; 6,900,897; 6,856,400; 7,042,573; 7,379,168; 7,388,673; 7,440,087; and 6,376,830, as well as in Exhibit E, which is hereby incorporated herein by reference.

A preferred system may be implemented using various commercial products available from Luna Technologies, which is a division of Luna Innovations Inc. of Roanoke, Va. Exemplary such products include the Distributed Sensing System™ 4300 and the Optical Backscatter Reflectometer (OBR)™, as well as various software available from Luna Technologies, such as Distributed Temperature and Strain Sensing Software.

Preferably, fiber fingerprinting is utilized to determine a baseline fingerprint of a fiber optic line, which can then be compared against fingerprints illustrating disturbances in a fiber optic line, which may indicate an attempted border transgression. It will be appreciated that constant phenomena in an area, such as, for example, running water, would be incorporated into such a baseline fingerprint, and thus not register as a constant disturbance. Preferably, the fiber optic lines and any corresponding software are configured to provide directional sensing capability.

In preferred implementations, hardware and software controlling the fiber optic sensing is self-learning. In at least one implementation, this self-learning is wholly automated, i.e. accomplished with no user input, while in another preferred implementation this self-learning is accomplished utilizing user input. For example, the system might detect a disturbance along a fiber optic line and trigger an alert. An individual might then observe via camera, or be dispatched to, an area where the alert originated and discover that a coyote triggered the alert. This information could then be utilized to inform the system that the sensed disturbance was a coyote. The next time that a similar disturbance is sensed, the system preferably either suggests that it might be a coyote, triggers an indicator that is flagged as a low-response warning, and/or dismisses it without issuing an alert.

The system 10 further includes modules 14 in electronic communication with the transgression sensors 12. Each module 14 may be in electronic communication with one, or more, transgression sensors 12. In implementations utilizing fiber optic lines, preferably the fiber optic lines both detect, at extended distances, entry of a subject into the sensing area, and, when a disturbance occurs in closer proximity, effect activation of a module 14 and/or camera.

In at least some preferred embodiments, a system utilizes one or more modules mounted on a pole, while in at least some other preferred embodiments, a system utilizes one or more modules which are disposed in the ground and configured to “pop up” upon activation or engagement. Exemplary such pop up, or “mole” surveillance modules are described in incorporated U.S. patent application Ser. No. 12/464,022, and the incorporated disclosure of provisional patent application No. 61/052,246, a copy of which is attached hereto as Exhibit C.

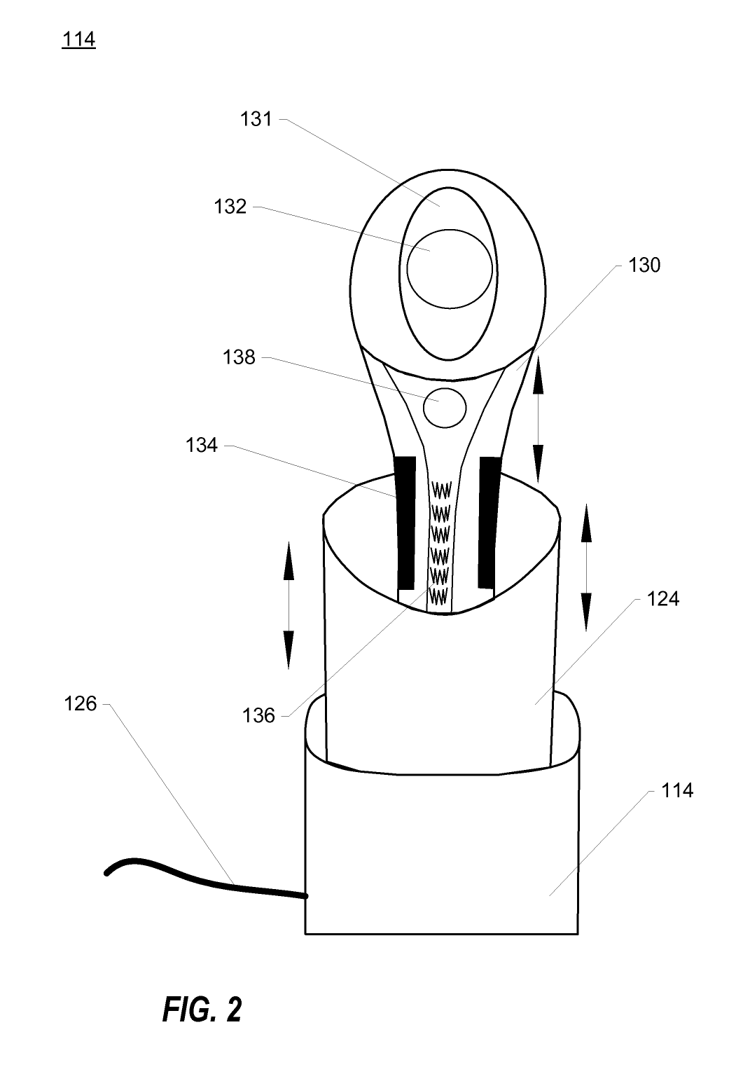

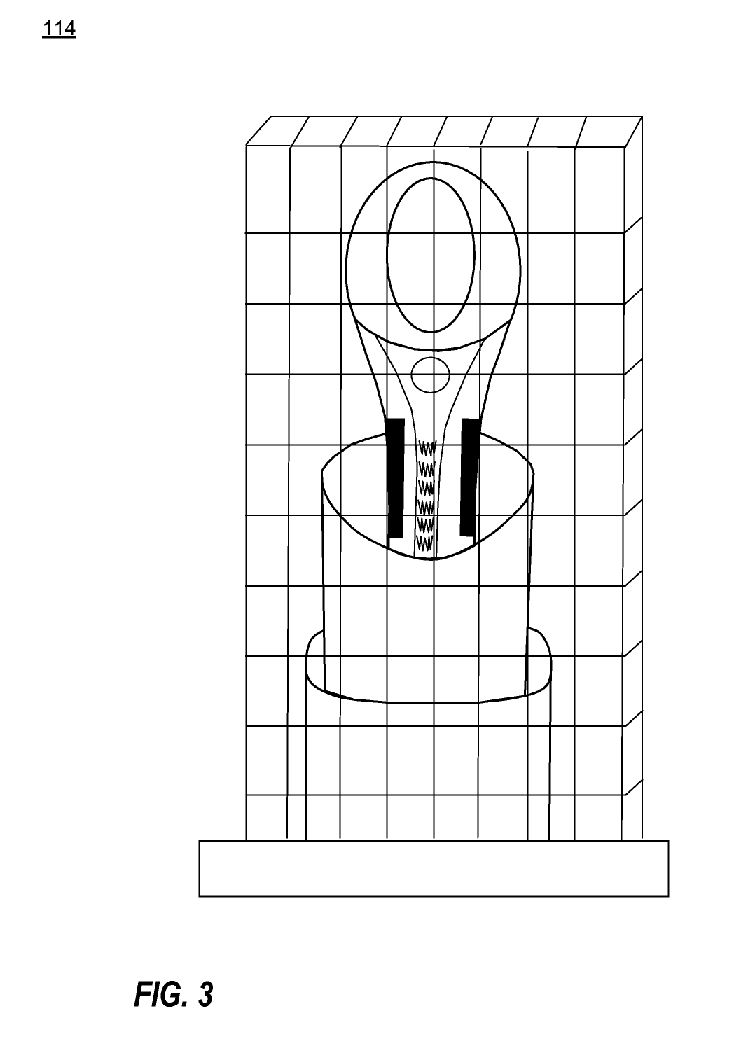

In a preferred implementation, a popup module 114 is housed underground in a casing 122 formed of cement or another difficult to penetrate material. A main body 130 of the module is configured to rise out of the casing until it is disposed above ground. In at least one implementation, the main body 130 is disposed within a cage 121 that also rises out of the casing 122, as illustrated in FIG. 3. Preferably, the main body 130 is disposed within a cylinder 124 which it is configured to rise out of, and, in preferred implementations, the cylinder 124 is itself configured to rise out of the casing 122, such that the module 114 can be characterized as a telescoping module, as illustrated in FIG. 2. The main body 130 preferably includes a camera 132, speakers 134, and a microphone 136. The camera 132 is preferably disposed inside of a protective globe 131. The module 114 further preferably includes one or more lights 138, for example, the module 114 may include two lights, one disposed on each of opposite sides of the module 114. The module 114 is preferably configured to provide three hundred and sixty degree surveillance capabilities, for example, by being configured such that the main body 130 and/or the camera 132 can swivel three hundred and sixty degrees.

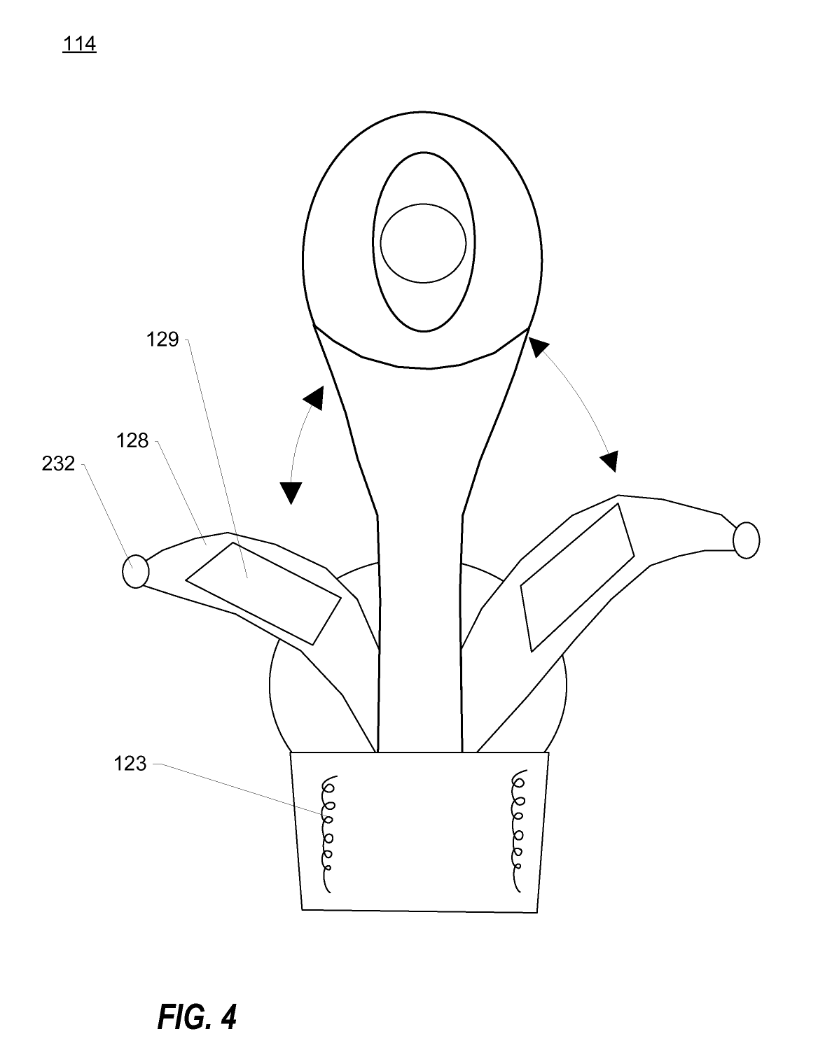

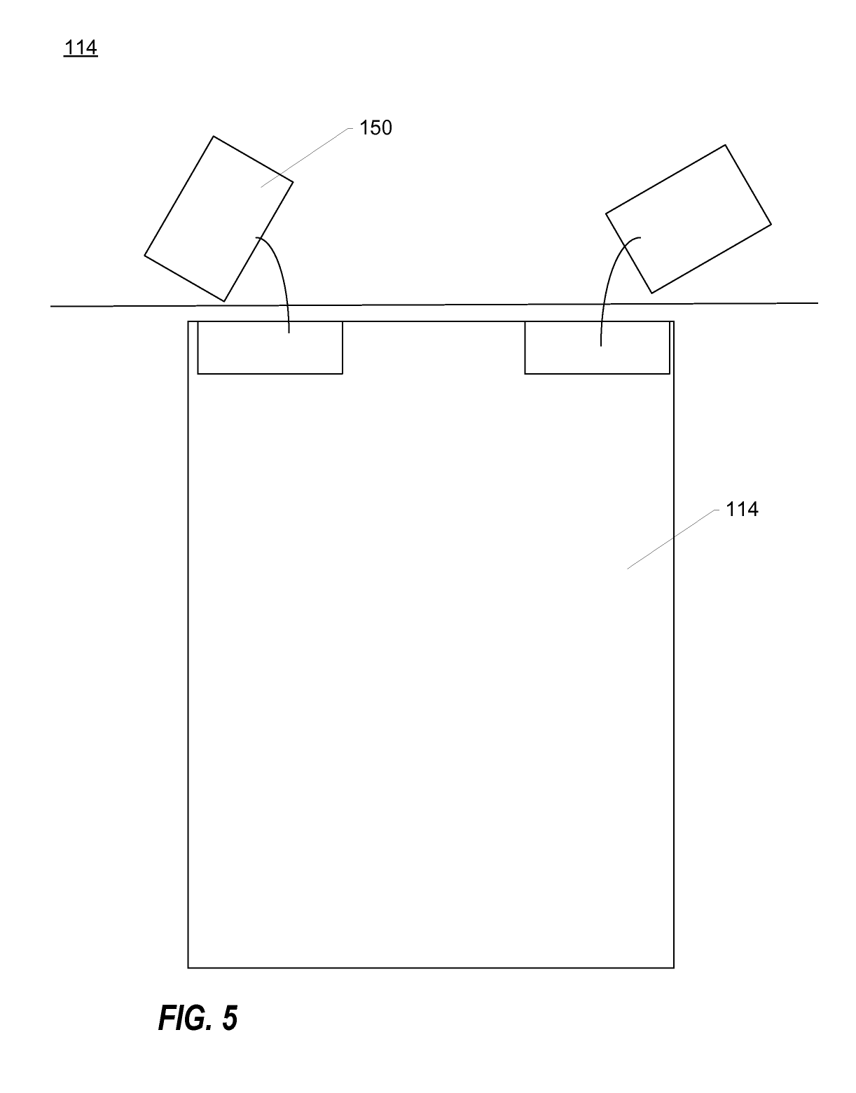

The module 114 preferably is attached to an underground power line 126, as exemplified in FIG. 1, and/or an aboveground solar panel 150, as illustrated in FIG. 5. In a preferred implementation, the module 114 includes one or more cover panels 128 configured to “peel” away from the main body, as illustrated in FIG. 4. Preferably, each cover panel 128 includes a solar panel or cell 129. In at least some embodiments, cameras 232 may alternatively or additionally be disposed proximate ends of cover panels 128, as illustrated in FIG. 4. In one or more preferred implementations, the module 114 includes one or more brushes 123 for cleaning a lens of the camera 132, when the camera is raised or lowered, as illustrated in FIG. 4.

In at least some preferred implementations, a module includes an electronic display (not illustrated), such as, for example, an LCD, plasma, or LED display. The electronic display is preferably a low energy screen, and preferably comprises a touch screen display. Alternatively, or additionally, a module includes one or more keys, or a keypad or keyboard.

Preferably, a module is configurable to output a preprogrammed message with audio and/or visual components, and is configured to allow for two way real time communications with one or more remote devices, either wirelessly or over one or more wired lines. Such remote devices can include both handheld devices and dedicated devices. For example, a remote device may include a computer terminal, a laptop, a personal computer, a cell phone, a smart phone, a PDA or PDA-like device, a net book, a custom handheld device configured for this purpose, or another computing device providing similar functionality. Such a remote device additionally may include a locator, such that its location, and thus the location of a person using it, may be determined. Such locator functionality may be accomplished via the use of GPS, or otherwise.

In preferred implementations, a handheld device is configured for both direct communications with a module, such as via radio or infrared, and infrastructure communications with a module, such as via the internet, a private network, a cellular network, and/or satellite. Preferably, a handheld device is configured to directly communicate with a module when in range for such direct communication, and to communicate via infrastructure when out of range of direct communication.

Preferably, each module is configured such that it can be both interacted with and controlled from a remote device. For example, in a preferred implementation, a user is able to pan, tilt, or zoom the video camera of a module via a remote device.

Preferably, each module includes a processor and is configured such that it provides functionality, such as, for example, a pre-programmed message or two way real time communication, subsequent to the occurrence of a trigger. A single module may be configured with multiple such triggers. In preferred implementations, one or more transgression sensors that are a part of, and/or in electronic communication with, a module are configured to trigger functionality of the module. For example, in a preferred implementation, a transgression sensor detects transgression of an area and alerts the module via an electronic communication. Receipt of this electronic communication at the module functions as a trigger, and causes the module to activate its video camera.

Further, the modules are preferably in electronic communication with one another. For example, in a preferred implementation, a module can track a subject, such as a person or vehicle, across its field of view and then communicate to another module that the subject is entering the other module's field of view.

A system in accordance with a preferred embodiment of the present invention allows modules to be placed in multiple locations in the positions that will be the most effective for monitoring, transgression detection, and/or communication. A system in accordance with a preferred embodiment of the present invention may include software configured to accomplish this purpose.

A remote handheld device allows a user to be mobile, and yet remain connected to information associated with monitoring. Remote devices allow for real time communication with one or more modules, and further allow for remote observation of the area proximate the module. A plurality of remote handheld devices operating as a system further provides the ability to maintain the location of a plurality of users spread over a large area.

A computer system in accordance with a preferred embodiment of the present invention may be configured to accommodate an assortment of components. The components may include both hardware and software components. Software components of the system may be updated periodically with enhancements, and may even be reconfigured as necessary. The software is designed to communicate, locate, monitor, observe, and educate persons in contact with the system. Hardware components of the system may include a module, a module activator, a PC, a mainframe, a server, a router, a handheld device, and electronic storage for information and video recorded or connected to the system, where necessary.

Wi-Fi connections may be utilized to connect a handheld device or other remote device in accordance with one or more preferred embodiments. A Wi-Fi connection may allow for the use of all handheld devices which are compatible with the network.

A system in accordance with a preferred embodiment of the present invention may be software driven. A software driven module in accordance with a preferred embodiment of the present invention may be updated, modified, and customized for even more robust applications, thus setting a device in accordance with a preferred embodiment of the present invention apart from others that are focused in specific areas.

Notably, although primarily described hereinabove in the context of transgression detection proximate a border, it will be appreciated that systems, methods, and apparatus described herein are equally applicable in other contexts. For example, in a preferred implementation, a detection system substantially similar to the transgression detection system 10 is utilized for facility security. Preferably, sensors, which may comprise fiber optic lines, are disposed, for example, in or on the lid of a locker, in or under flooring of a facility, or in the walls of a facility, such as, for example, in drywall of a facility. Modules in accordance with one or more preferred implementations described hereinabove are then utilized in combination with such sensors.

Similar systems are explicitly contemplated for use with residential and commercial real property, such as, for example, for monitoring transgression, i.e. trespassing, on public or privately owned property or grounds.

Based on the foregoing description, it will be readily understood by those persons skilled in the art that the present invention is susceptible of broad utility and application. Many embodiments and adaptations of the present invention other than those specifically described herein, as well as many variations, modifications, and equivalent arrangements, will be apparent from or reasonably suggested by the present invention and the foregoing descriptions thereof, without departing from the substance or scope of the present invention. Accordingly, while the present invention has been described herein in detail in relation to one or more preferred embodiments, it is to be understood that this disclosure is only illustrative and exemplary of the present invention and is made merely for the purpose of providing a full and enabling disclosure. The foregoing disclosure is not intended to be construed to limit the present invention or otherwise exclude any such other embodiments, adaptations, variations, modifications or equivalent arrangements.

1-3. (canceled)

4. A system for transgression detection comprising:
(a) a plurality of modules, each module comprising
(i) a video camera,
(ii) a microphone,
(iii) an electronic display, and
(iv) a processor;
(b) a plurality of sensors, each sensor configured for electronic communication with at least one of the plurality of modules; and
(c) a remote device configured to allow a user to both
(i) control a module via electronic communication, and
(ii) interact with a module via electronic communication;
(d) wherein at least one module of the plurality of modules is configured to be triggered by a communication from a sensor of the plurality of sensors.

5. The system of claim 4, wherein the remote device is a handheld device.

6. The system of claim 5, wherein the handheld device is configured for direct communications with a module of the plurality of modules when in range of the module, and is configured for infrastructure communications via a network with the module when not in range of the module.

7. The system of claim 4, wherein each sensor of said plurality of sensors comprises a fiber optic line.

8. The system of claim 7, wherein each fiber optic line is buried.

9. The system of claim 8, wherein each fiber optic line is buried between one and a half and two feet below ground level.
